(19) United States
(12) Patent Application Publication
(10) Pub. No.: US 2021/0253133 A1
(43) Pub. Date: Aug. 19, 2021

(54) VEHICLE CONTROL DEVICE AND VEHICLE

(71) Applicant: HONDA MOTOR CO., LTD., Tokyo (JP)

(72) Inventors: Kouhei MIYAMOTO, Tokyo (JP); Jun OCHIDA, Wako-shi (JP)

(21) Appl. No.: 17/168,389

(22) Filed: Feb. 5, 2021

(30) Foreign Application Priority Data
Feb. 14, 2020 (JP) 2020-023634

(51) Int. Cl. B60W 60/00; B60W 50/08

(52) U.S. Cl. CPC B60W 60/0053; B60W 2050/0072; B60W 60/00186; B60W 50/082

(57) ABSTRACT

A vehicle control device for controlling automated driving of a vehicle is provided. The device comprises a first control unit configured to perform driving control of the vehicle; and a second control unit configured to perform driving control of the vehicle according to at least a substitution instruction from the first control unit, wherein when the first control unit transmits the substitution instruction to the second control unit, the first control unit holds, for a predetermined amount of time, information indicating a state of control of automated driving to be transmitted to the second control unit.

### CROSS-REFERENCE TO RELATED APPLICATION(S)

This application claims priority to and the benefit of Japanese Patent Application No. 2020-23634 filed on Feb. 14, 2020, the entire disclosure of which is incorporated herein by reference.

### BACKGROUND OF THE INVENTION

### Field of the Invention

The present invention relates to technology for controlling a vehicle.

### Description of the Related Art

Various technologies for implementing automated driving of a vehicle have been proposed. In International Publication No. 2019/116870, a configuration in described in which a first driving control unit for controlling the driving of a vehicle and a second driving control unit for controlling the driving of a vehicle are provided, and when functional deterioration is detected in one of the driving control units, the other is used for substitution control. By having a configuration with redundancy in terms of including a plurality of vehicle driving control units, the reliability of the automated driving control of a vehicle is improved.

When switching the main controlling unit from the first driving control unit to the second driving control unit, the control state of the first driving control unit must be handed over to the second driving control unit. In a case where handing over the control state is not performed appropriately, the control currently performed by the first driving control unit may have to be started from the beginning again by the second driving control unit, or the second driving control unit may perform driving control using an inappropriate control state as a reference.

### SUMMARY OF THE INVENTION

The present invention, when substitution control is performed, the control state is appropriately taken over and a smooth transition to a different main controlling unit is implemented.

According to an aspect of the present invention, provided is a vehicle control device for controlling automated driving of a vehicle, including:

a first control unit configured to perform driving control of the vehicle; and

a second control unit configured to perform driving control of the vehicle according to at least a substitution instruction from the first control unit,

wherein when the first control unit transmits the substitution instruction to the second control unit, the first control unit holds, for a predetermined amount of time, information indicating a state of control of automated driving to be transmitted to the second control unit.

According to another aspect of the present invention, provided is a vehicle that performs driving control by a vehicle control device for controlling automated driving of the vehicle,

the vehicle control device including:

a first control unit configured to perform driving control of the vehicle; and

a second control unit configured to perform driving control of the vehicle according to at least a substitution instruction from the first control unit,

wherein when the first control unit transmits the substitution instruction to the second control unit, the first control unit holds, for a predetermined amount of time, information indicating a state of control of automated driving to be transmitted to the second control unit.

According to the present invention, the control state can be appropriately taken over and a smooth transition to a different main controlling unit can be implemented.

### BRIEF DESCRIPTION OF THE DRAWINGS

FIG. 1 is a block diagram illustrating a vehicle control device according to an embodiment.

FIG. 2 is a block diagram illustrating a vehicle control device according to an embodiment.

FIG. 3 is a block diagram illustrating a vehicle control device according to an embodiment.

FIG. 4 is a block diagram illustrating a vehicle control device according to an embodiment.

FIG. 5 is a block diagram of an automated driving ECU and a driving control ECU according to an embodiment.

FIGS. 6A to 6D are timing diagrams illustrating examples of signal generation by an output signal management unit.

FIGS. 7A to 7C are diagrams illustrating examples of the flow of control performed by a driving control ECU.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

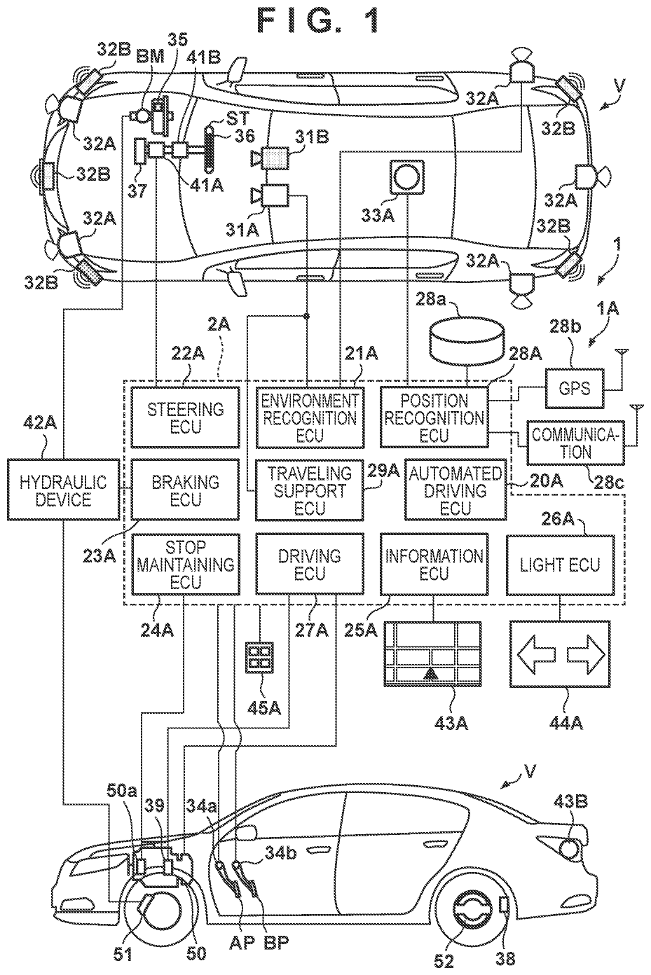

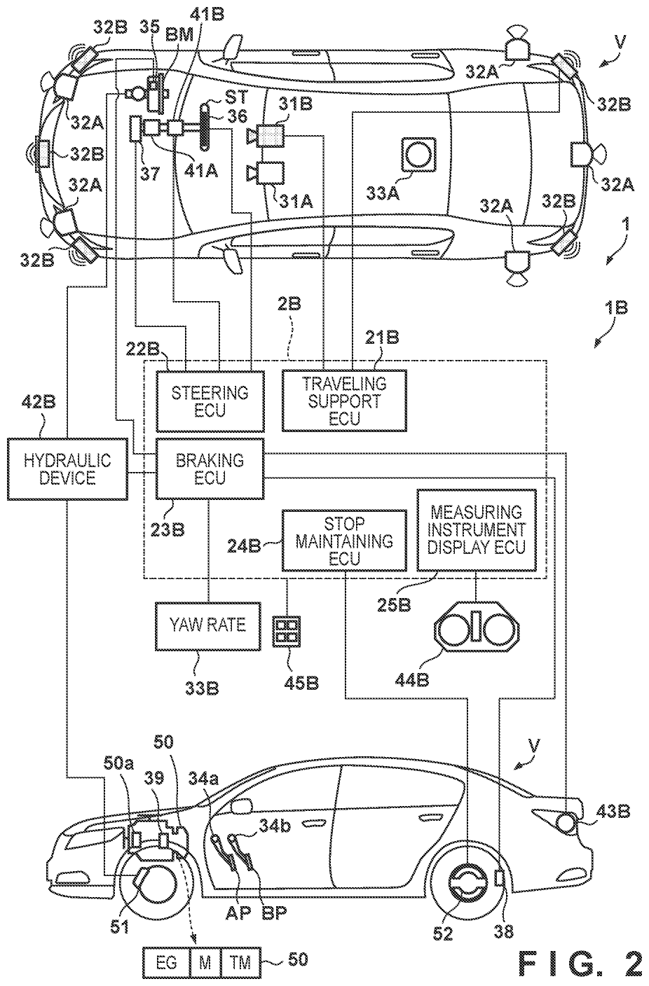

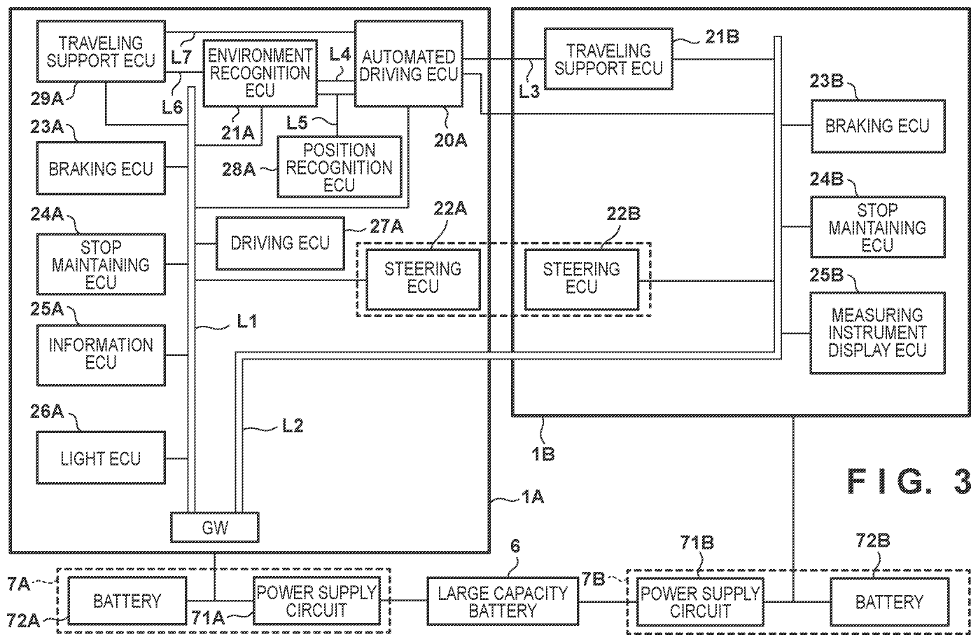

FIGS. 1 to 4 are block diagrams of a vehicle control device 1 (control system) according to an embodiment of the present invention. The vehicle control device 1 controls a vehicle V. In FIGS. 1 and 2, an outline of the vehicle V is illustrated in a plan view and a side view. The vehicle V is a sedan type four-wheeled passenger vehicle, for example. The vehicle control device 1 includes a first control unit 1A and a second control unit 1B. FIG. 1 is a block diagram illustrating the configuration of the first control unit 1A. FIG. 2 is a block diagram illustrating the configuration of the second control unit 1B. FIG. 3 illustrates communication lines between the first control unit 1A and the second control unit 1B and the configuration of power sources.

The first control unit 1A and the second control unit B are overlapping or redundant units when it comes to performing one or more functions implemented by the vehicle V. In this manner, the reliability of the system can be improved. The first control unit 1A, for example, performs automated driving control, normal operation control involving manual driving, as well as assisted driving control involving danger avoidance and the like. The second control unit 1B mainly controls assisted driving involving danger avoidance. The term “assisted driving” may also be referred to as “driving assistance”. Though the first control unit 1A and the second control unit 1B are redundant in terms of one or more functions, by the units also executing different control processing, the control processing can be distributed and reliability can be improved.

The vehicle V of the present embodiment is a parallel hybrid vehicle. FIG. 2 schematically illustrates the configuration of a power plant 50 that outputs driving force to rotate the drive wheels of the vehicle V. The power plant 50 includes an internal combustion engine EG, a motor M. and an automatic transmission TM. The motor M can be used as a drive source for accelerating the vehicle V and can also be used as a power generator when the vehicle V decelerates and the like (regenerative braking).

First Control Unit 1A

The configuration of the first control unit 1A will be described with reference to FIG. 1. The first control unit 1A includes an engine control unit (ECU) group (control unit group) 2A. The ECU group 2A includes a plurality of ECUs 20A to 29A. Each ECU includes a processor, represented by a CPU, a storage device, such as a semiconductor memory, an interface with an external device, and the like. The storage device stores programs executed by the processor, data used in the processing executed by the processor, and the like. Each ECU may include a plurality of processors, storage devices, and interfaces. Note that the number of ECUs and the assigned functions can be designed as appropriate, and the design may include more subdivision or integration than the present embodiment. Note that in FIGS. 1 to 3, the ECUs 20A to 29A are labelled with their representative function. For example, ECU 20A is labelled “automated driving ECU”.

ECU 20A executes control involving automated driving as driving control of the vehicle V. Automated driving involves automatically performing at least one of driving of the vehicle V (accelerating the vehicle V via the power plant 50 and the like), steering, and braking without driver operation. In the present embodiment, driving, steering, and braking are automatically performed.

The ECU 21A is an environment recognition unit that recognizes the environment the vehicle V is travelling in on the basis of detection results from detection units 31A. 32A that detect the state of the surroundings around the vehicle V. The ECU 21A generates target data, which will be described below, as surrounding environment information.

In the present embodiment, the detection unit 31A is an imaging device (also referred to as camera 31A below) that detects objects around the vehicle V via imaging. The camera 31A is provided inside the vehicle V in a manner allowing it to capture images of what in front of the vehicle V. By analyzing the images captured by the camera 31A, the outline of a target, the line (white line or the like) separating lanes on the road, and the like can be extracted.

In the present embodiment, the detection unit 32A is a lidar (Light Detection and Ranging) unit (also referred to as lidar 32A below) that detects objects around the vehicle V by light, detects a target around the vehicle V, and measures the distance to the target. In the present embodiment, five lidars 32A are provided with one being provided at each corner on the front portion of the vehicle V, one at a central rear portion, and one on each side of the rear portion. The number and arrangement of the lidars 32A can be set as appropriate.

The ECU 29A is an assisted driving unit that performs control involving assisted driving (also referred to as driving assistance) as driving control of the vehicle V on the basis of the detection result of the detection unit 31A.

The ECU 22A is a steering control unit that controls an electric power steering device 41A. The electric power steering device 41A includes a mechanism for steering the front wheels according to a driver operation (steering operation) using a steering wheel ST. The electric power steering device 41A includes a motor that assists the steering operation or generates a driving force for the automatic steering of the front wheels, a sensor that detects the rotation amount of the motor, a torque sensor that detects the steering torque exerted on the driver, and the like.

The ECU 23A is a braking control unit that controls a hydraulic device 42A. The hydraulic device 42A implements electric servo brake (ESB), for example. A braking operation by the driver using a brake pedal BP is converted to hydraulic pressure at a brake master cylinder BM, and the hydraulic pressure is then transmitted to the hydraulic device 42A. The hydraulic device 42A is an actuator that can control the hydraulic pressure of a working fluid supplied to a brake device (for example, a disc brake device) 51 provided for each of the four wheels on the basis of the hydraulic pressure transmitted from the brake master cylinder BM, and the ECU 23A performs drive control of an electromagnetic valve and the like provided in the hydraulic device 42A. In the present embodiment, the ECU 23A and the hydraulic device 42A constitute the electric servo brake, and the ECU 23A, for example, controls the distribution of the braking force from the four brake devices 51 and the braking force by regenerative braking of the motor M.

The ECU 24A is a stop maintaining control unit that controls an electric parking lock device 50a provided in the automatic transmission TM. The electric parking lock device 50a includes a mechanism that locks an internal mechanism of the automatic transmission TM mainly when a P range (parking range) is selected. The ECU 24A can control locking and unlocking by the electric parking lock device 50a.

The ECU 25A is an in-vehicle report control unit that controls an information output device 43A for reporting information inside the vehicle. The information output device 43A includes, for example, a display device, such as a head-up display, and an audio output device. A vibration device may also be included. ECU 25A causes the information output device 43A to output, for example, various kinds of information, such as the vehicle speed and the outside temperature, and information of course guidance and the like.

The ECU 26A is an outside-vehicle report control unit that controls an information output device 44A for reporting information outside the vehicle. In the present embodiment, the information output device 44A is a direction indicator (hazard lamp), and the ECU 26A can report the advancement direction of the vehicle V to the outside of the vehicle by performing blinking control of the information output device 44A as the direction indicator, and can increase the attention toward the vehicle V from the outside of the vehicle by performing blinking control of the information output device 44A as the hazard lamp.

The ECU 27A is a drive control unit that controls the power plant 50. In the present embodiment, although one ECU 27A is assigned to the power plant 50, one ECU may be assigned to each of the internal combustion engine EG, the motor M. and the automatic transmission TM. The ECU 27A controls the output of the internal combustion engine EG and the motor M, and switches the gear range of the automatic transmission TM, corresponding to, for example, a driver operation detected by an operation detection sensor 34a provided in an accelerator pedal AP or an operation detection sensor 34b provided in the brake pedal BP, the vehicle speed, and the like (see FIG. 2). Note that a rotation speed sensor 39 that detects the rotation speed of an output shaft of the automatic transmission TM is provided in the automatic transmission TM as a sensor that detects the traveling state of the vehicle V. The vehicle speed of the vehicle V can be calculated from the detection result of the rotation speed sensor 39.

The ECU 28A is a position recognition unit that recognizes the current position and the course of the vehicle V. The ECU 28A performs control and information processing of the detection results or communication results of a gyro sensor 33A, a GPS sensor 28b, and a communication device 28c. The gyro sensor 33A detects the rotary motion of the vehicle V. The course of the vehicle V can be determined from the detection result of the gyro sensor 33A. The GPS sensor 28b detects the current position of the vehicle V. The communication device 28c performs wireless communication with a server providing map information and traffic information, and obtains these kinds of information. A database 28a can store highly accurate map information, and the ECU 28A can specify the position of the vehicle V in a lane with a higher degree of accuracy, on the basis of this map information and the like.

An input device 45A is disposed inside the vehicle in a manner allowing it to be operated by the driver and receives instructions from the driver and the input of information.

### Second Control Unit 1B

The configuration of the second control unit 1B will be described with reference to FIG. 2. The second control unit 1B includes an engine control unit (ECU) group (control unit group) 2B. The ECU group 2B includes a plurality of ECUs 21B to 25B. Each ECU includes a processor, represented by a CPU, a storage device, such as a semiconductor memory, an interface with an external device, and the like. The storage device stores programs executed by the processor, data used in the processing executed by the processor, and the like. Each ECU may include a plurality of processors, storage devices, and interfaces. Note that the number of ECUs and the assigned functions can be designed as appropriate, and the design may include more subdivision or integration than the present embodiment. Note that, as with the ECU group 2A, in FIGS. 2 and 3, the ECUs 21B to 25B are labelled with their representative function.

The ECU 21B is an environment recognition unit that recognizes the environment the vehicle V is travelling in on the basis of detection results from detection units 31B, 32B that detect the state of the surroundings around the vehicle V and also an assisted driving unit that performs control involving assisted driving (also referred to as driving assistance) as driving control of the vehicle V. The ECU 21B generates target data, which will be described below, as surrounding environment information.

Note that, although the ECU 21B has a configuration including an environment recognition function and an assisted driving function in the present embodiment, an ECU may be provided for each of the functions, as with the ECU 21A and the ECU 29A of the first control unit 1A. Conversely, in the first control unit 1A, one ECU may be provided to implement the functions of the ECU 21A and the ECU 29A, as with the ECU 21B.

In the present embodiment, the detection unit 31B is an imaging device (also referred to as camera 31B below) that detects objects around the vehicle V via imaging. The camera 31B is provided inside the vehicle V in a manner allowing it to capture images of what in front of the vehicle V. By analyzing the images captured by the camera 31B, the outline of a target, the line (white line or the like) separating lanes on the road, and the like can be extracted. In the present embodiment, the detection unit 32B is a millimeter-wave radar (also referred to as radar 32B below) that detects objects around the vehicle V by radio waves, detects a target around the vehicle V, and measures the distance to the target. In the present embodiment, five radars 32B are provided with one being provided at a central front portion of the vehicle V, one at each corner of the front portion, and one at each corner of the rear portion. The number and arrangement of the radars 32B can be set as appropriate.

The ECU 22B is a steering control unit that controls an electric power steering device 41B. The electric power steering device 41B includes a mechanism for steering the front wheels according to a driver operation (steering operation) using the steering wheel ST. The electric power steering device 41B includes a motor that assists the steering operation or generates a driving force for the automatic steering of the front wheels, a sensor that detects the rotation amount of the motor, a torque sensor that detects the steering torque exerted on the driver, and the like. Additionally, a steering angle sensor 37 is electrically connected to the ECU 22B via a communication line L2 described below, and can control the electric power steering device 41B on the basis of the detection result of the steering angle sensor 37. The ECU 22B can obtain the detection result of a sensor 36 that detects whether or not the driver is gripping the steering wheel ST, and can monitor the driver's gripping state.

The ECU 23B is a braking control unit that controls a hydraulic device 42B. The hydraulic device 42B implements vehicle stability assist (VSA), for example. A braking operation by the driver using the brake pedal BP is converted to hydraulic pressure at the brake master cylinder BM, and the hydraulic pressure is then transmitted to the hydraulic device 42B. The hydraulic device 42B is an actuator that can control the hydraulic pressure of a working fluid supplied to the brake devices 51 of the wheels on the basis of the hydraulic pressure transmitted from the brake master cylinder BM, and the ECU 23B performs drive control of an electromagnetic valve and the like provided in the hydraulic device 42B.

In the present embodiment, the ECU 23B and the hydraulic device 42B are electrically connected to a wheel speed sensor 38 provided for each of the four wheels, a yaw rate sensor 33B, and a pressure sensor 35 that detects the pressure in the brake master cylinder BM, and on the basis of the detection results of these, an ABS function, traction control, and the attitude control function of the vehicle V are implemented. For example, the ECU 23B adjusts the braking force of each of the wheels on the basis of the detection result of the wheel speed sensor 38 provided for each of the four wheels, and suppresses wheel slip. Additionally, the braking force of each wheel is adjusted on the basis of the rotational angular velocity about a vertical axis of the vehicle V detected by the yaw rate sensor 33B, and sudden changes in the attitude of the vehicle V are suppressed.

The ECU 23B also functions as an outside-vehicle report control unit that controls an information output device 43B for reporting information outside the vehicle. In the present embodiment, the information output device 43B is a brake lamp, and the ECU 23B can turn on the brake lamp at the time of braking and the like. In this manner, attention toward the vehicle V from the following vehicle can be increased.

The ECU 24B is a stop maintaining control unit that controls an electric parking brake device (for example, a drum brake) 52 provided in the rear wheels. The electric parking brake device 52 includes a mechanism for locking the rear wheel. The ECU 24B can control locking and unlocking of the rear wheels by the electric parking brake device 52.

The ECU 25B is an in-vehicle report control unit that controls an information output device 44B for reporting information inside the vehicle. In the present embodiment, the information output device 44B includes a display device disposed in the instrument panel. The ECU 25B can cause the information output device 44B to output various kinds of information, such as the vehicle speed, the fuel consumption, and the like.

An input device 45B is disposed inside the vehicle in a manner allowing it to be operated by the driver and receives instructions from the driver and the input of information.

### Communication Line

An example of communication lines of the vehicle control device 1 that communicatively connect the ECUs will be described with reference to FIG. 3. The vehicle control device 1 includes wired communication lines L1 to L7. The ECUs 20A to 27A and 29A of the first control unit 1A are connected to the communication line L1. Note that the ECU 28A may also be connected to the communication line L1.

The ECUs 21B to 25B of the second control unit 1B are connected to the communication line L2. Also, the ECU 20A of the first control unit 1A is connected to the communication line L2. The communication line L3 connects the ECU 20A and the ECU 21B to one another. The communication line L4 connects the ECU 20A and the ECU 21A to one another. The communication line L5 connects the ECU 20A, the ECU 21A, and the ECU 28A to one another. The communication line L6 connects the ECU 29A and the ECU 21A to one another. The communication line L7 connects the ECU 29A and the ECU 20A to one another.

Although the protocols of the communication lines L1 to L7 may be the same or may be different, the protocols may be different according to the communication environment, such as communication speed, traffic, and durability. For example, the communication lines L3 and L4 may be an Ethernet (registered trademark) in terms of communication speed. Also, the communication lines L1, L2 and L5 to L7 may be a controller area network (CAN).

The first control unit 1A includes a gateway GW. The gateway GW relays the communication line L1 to the communication line L2. Therefore, for example, the ECU 21B can output a control command to the ECU 27A via the communication line L2, the gateway GW, and the communication line L1.

Power Source

The power source of the vehicle control device 1 will be described with reference to FIG. 3. The vehicle control device 1 includes a large-capacity battery 6, a power source 7A, and a power source 7B. The large-capacity battery 6 is a battery for driving the motor M and is the battery charged by the motor M.

The power source 7A is a power source that supplies electric power to the first control unit 1A and includes a power source circuit 71A and a battery 72A. The power source circuit 71A is a circuit that supplies the electric power of the large-capacity battery 6 to the first control unit 1A and reduces, for example, the output voltage (for example, 190 V) of the large-capacity battery 6 to a reference voltage (for example, 12 V). The battery 72A is a 12 V lead battery, for example. By providing the battery 72A, even when the power supply of the large-capacity battery 6 and the power source circuit 71A is cut off or decreased, electric power can be supplied to the first control unit 1A.

The power source 7B is a power source that supplies electric power to the second control unit 1B and includes a power source circuit 71B and a battery 72B. The power source circuit 71B is a circuit similar to the power source circuit 71A and is a circuit that supplies the electric power of the large-capacity battery 6 to the second control unit 1B. The battery 72B is a battery similar to the battery 72A and is a 12 V lead battery, for example. By providing the battery 72B, even when the power supply of the large-capacity battery 6 and the power source circuit 71B is cut off or decreased, electric power can be supplied to the second control unit 1B.

General Configuration

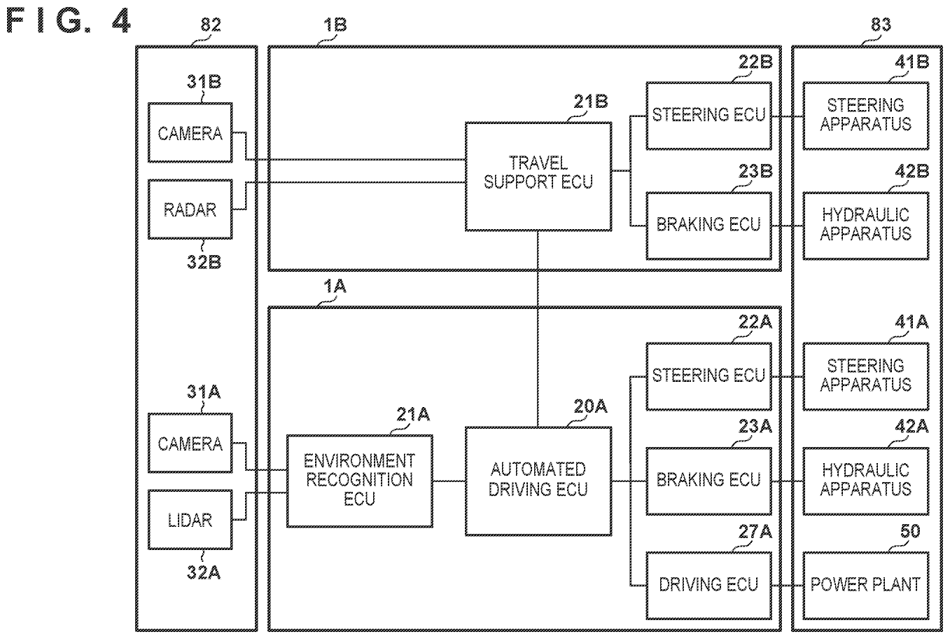

The general configuration of the vehicle V will be described with reference to FIG. 4 from a different perspective. The vehicle V includes the first control unit 1A, the second control unit 1B, an external world recognition device group 82 and an actuator group 83. In FIG. 4, the ECU 20A, the ECU 21A, the ECU 22A, the ECU 23A, and the ECU 27A are illustrated as examples of the ECUs included in the first control unit 1A, and the ECU 21B, the ECU 22B, and the ECU 23B are illustrated as examples of the ECUs including in the second control unit 1B.

The external world recognition device group 82 is an assembly of external world recognition devices (sensors) mounted on the vehicle V. The external world recognition device group 82 includes the camera 31A, the camera 31B, the lidar 32A, and the radar 32B described above, for example. In the present embodiment, the camera 31A and the lidar 32A are connected to the ECU 21A of the first control unit 1A and operate according to instructions from the ECU 21A (in other words, are controlled by the first control unit 1A). The ECU 21A obtains external world information obtained by the camera 31A and the lidar 32A and supplies the external world information to the ECU 20A of the first control unit 1A. Also, the camera 31B and the radar 32B are connected to the ECU 21B of the second control unit 1B and operate according to instructions from the ECU 21B (in other words, are controlled by the second control unit 1B). The ECU 21B obtains external world information obtained by the camera 31B and the radar 32B and supplies the external world information to the ECU 20A of the first control unit 1A. In this manner, the first control unit 1A (the ECU 20A) can execute automated driving control using the external world information obtained from the camera 31A, the camera 31B, the lidar 32A, and the radar 32B.

The actuator group 83 is an assembly of actuators mounted on the vehicle V. The actuator group 83 includes the electric power steering device 41A, the electric power steering device 41B, the hydraulic device 42A, the hydraulic device 42B, and the power plant 50 described above, for example. The electric power steering device 41A and the electric power steering device 41B are steering actuators for steering the vehicle V. The hydraulic device 42A and the hydraulic device 42B are braking actuators for braking the vehicle V. Also, the power plant 50 is a driving actuator for driving the vehicle V.

In the present embodiment, the electric power steering device 41A, the hydraulic device 42A, and the power plant 50 are connected to the ECU 20A via the ECU 22A, the ECU 23A, and the ECU 27A and operate according to instructions from the ECU 20A (in other words, are controlled by the first control unit 1A). Also, electric power steering device 41B and the hydraulic device 42B are connected to the ECU 21B via the ECU 22B and the ECU 23B and operate according to instructions from the ECU 21B (in other words, are controlled by the second control unit 1B).

The first control unit 1A (the ECU 20A) communicates with apart of the external world recognition device group 82 (the camera 31A and the lidar 32A) via a communication channel and communicates with a part of the actuator group 83 (the electric power steering device 41A, the hydraulic device 42A, and the power plant 50) via a different communication channel. Also, the second control unit 1B (the ECU 21B) communicates with a part of the external world recognition device group 82 (the camera 31B and the radar 32B) via a communication channel and communicates with a part of the actuator group 83 (the electric power steering device 41B and the hydraulic device 42B) via a different communication channel. The communication channel connects to the ECU 20A and the communication channel connected to the ECU 21B may be different from one another. These communication channels may be a CAN (controller area network) or may be an Ethernet (registered trademark), for example. Also, the ECU 20A and the ECU 21B are connected to one another via the communication line L3. The communication line L3 may be a CAN (controller area network) or may be an Ethernet (registered trademark), for example. Also, both CAN and an Ethernet (registered trademark) may be used for connection.

The first control unit 1A (ECU 20A) is constituted by a processor such as a CPU and a memory such as RAM and is configured to execute driving control of the vehicle V (for example, automated driving control). For example, the ECU 20A obtains via the ECU 21A the external world information obtained by the camera 31A and the lidar 32A and obtains via the ECU 21B the external world information obtained by the camera 31B and the radar 32B as the external world information obtained by the external world recognition device group 82. Also, the ECU 20A, on the basis of the obtained external world information, generates the correct course and speed for the vehicle V during automated driving and determines a target control amount (driving amount, braking amount, steering amount) of the vehicle V for implementing this course and speed. The ECU 20A generates an operation amount (a command value (signal value), such as voltage or current) of each actuator on the basis of the determined target control amount of the vehicle V and controls the actuator group 83 (the electric power steering device 41A, the hydraulic device 42A, and the power plant 50) using these operation amounts. This allows the driving control (for example, automated driving) of the vehicle V to be performed.

The ECU 20A can operate as a detecting unit that detects a decrease in the driving control functionality of the vehicle V performed by the first control unit 1A. For example, the ECU 20A can monitor the communication states of the communication channels with the external world recognition device group 82 and the communication channels with the actuator group 83 and detect a decrease in the communication functionality with the external world recognition device group 82 and the actuator group 83 on the basis of the communication states, allowing a decrease in driving control functionality to be detected. A decrease in communication functionality may include communications being disconnected, a decrease in communication speed, and the like. Also, the ECU 20A may detect a decrease in the driving control functionality by detecting a decrease in the performance of the external world recognition device group 82 detecting the external world or a decrease in the driving performance of the actuator group 83. Furthermore, in a case where the ECU 20A is configured to diagnose its own processing performance (for example, processing speed), a decrease in the driving control functionality may be detected on the basis of the diagnosis result. Note that in the present embodiment, the ECU 20A operates as a detecting unit that detects a decrease in its own driving functionality. However, no such limitation is intended, and the detecting unit may be provided separate from the ECU 20A or the second control unit 1B (for example, the ECU 21B) may operate as the detecting unit.

The second control unit 1B (ECU 21B) is constituted by a processor such as a CPU and a memory such as RAM and is configured to execute driving control of the vehicle V. As with the ECU 20A of the first control unit 1A, the ECU 21B can determine a target control amount (braking amount, steering amount) of the vehicle V, generates an operation amount for each actuator on the basis on the determined target control amount, and control the actuator group 83 (the electric power steering device 41B and the hydraulic device 42B) using these operation amounts. However, the ECU 21B has a lower processing performance than the ECU 20A in terms of performing driving control of the vehicle V. Processing performance may be compared using clock speed or benchmark test results, for example. In normal operation when no decrease in driving control functionality has been detected in the ECU 20A, the ECU 21B obtains the external world information obtained by the camera 31B and the radar 32B and supplies the external world information to the ECU 20A. However, when a decrease in driving control functionality is detected in the ECU 20A, the ECU 21B performs driving control of the vehicle V instead of the ECU 20A (in other words, substitution control). Substitution control, for example, may include degraded control in which functionality restriction is performed to decrease the control level of the automated driving of the vehicle V, depending on the control level.

When a decrease in the functionality of the external world recognition or an actuator under the control of the ECU 20A is detected, the ECU 20A transmits a degrade execution instruction to the ECU 21B via the communication line L3. This switches the main performing unit of driving control from the ECU 20A to the ECU 21B. While the main controlling unit of driving control (or automated driving) is the ECU 20A, the ECU 21B functions as a slave processor to the ECU 20A functioning as a master processor. When the ECU 21B receives a degrade execution instruction from the ECU 20A, the ECU 21B starts performing driving control (in the present example, degraded control) with itself as the main performing unit. In the present example, the degraded control performed by the ECU 21B may be driving control including switching the driving from automated driving to manual driving and, when such takeover is not performed, stopping the vehicle until takeover is completed or until the vehicle is stopped. Note that in the present example, the sensor 36 that detects whether or not the driver is gripping the steering wheel ST belongs to the second control unit 1B. Thus, the completion of takeover can be determined by the sensor 36 detecting the steering wheel ST being gripped.

Degraded Control

To provide automated driving (including monitoring necessary (hands off), monitoring unnecessary (eyes off)), the following functions are necessary: (i) redundancy in control system configuration, (ii) map, (iii) wheel grip sensor or driver surveillance camera, (iv) external world recognition, such as camera, radar, and lidar, (v) adaptive cruise control, lane keeping assistance function, and the like. When a decrease in the functionality of any one of these occurs, redundancy is lost, making appropriately reacting to another decrease in functionality difficult. However, with degraded control, control is degraded to a driving level that does not use the function that lost redundancy. This is degraded control. Degraded control is, in a case where a decrease in the functionality of the first control unit 1A is detected, for example, control is performed with the remaining functionality to continue automated driving or to switch to manual driving or stop the vehicle. Regarding degraded control, the control system is taken over as follows.

(1) In a case where a decrease in the functionality of the first control unit 1A or the like has occurred and degraded control can be performed by the first control unit 1A, the first control unit 1A continues performing control.

(2) In a case where a decrease in the functionality of the first control unit 1A has occurred and degraded control is unable to be performed by the first control unit 1A, a degrade execution instruction is sent to the second control unit 1B. In this case, the second control unit B performed degraded control. The degrade execution instruction sent to the second control unit 1B can be an instruction to the second control unit 1B to take over control or a substitution instruction.

(3) In a case where a decrease in the functionality of the second control unit 1B has occurred and degraded control is unable to be performed, the first control unit 1A is notified of this and the first control unit 1A continues performing control (in this case also, the first control unit 1A may perform degraded control as control redundancy has been lost).

(4) In a case where the instruction from the first control unit 1A does not reach the second control unit 1B, the second control unit 1B determines to cut communications from the first control unit 1A and the second control unit 1B performs degraded control.

As described above, in degraded control, the main performing unit of degraded control may change. For example, in example (2) described above, a degrade execution instruction is transmitted from the first control unit 1A to the second control unit 1B, causing the second control unit 1B to perform degraded control. In the present embodiment, example (2) described above is used to describe the generation of a signal (or a forming of a signal) to be transmitted from the first control unit 1A to the second control unit 1B.

Management of Output Signal from Automated Driving ECU 20A

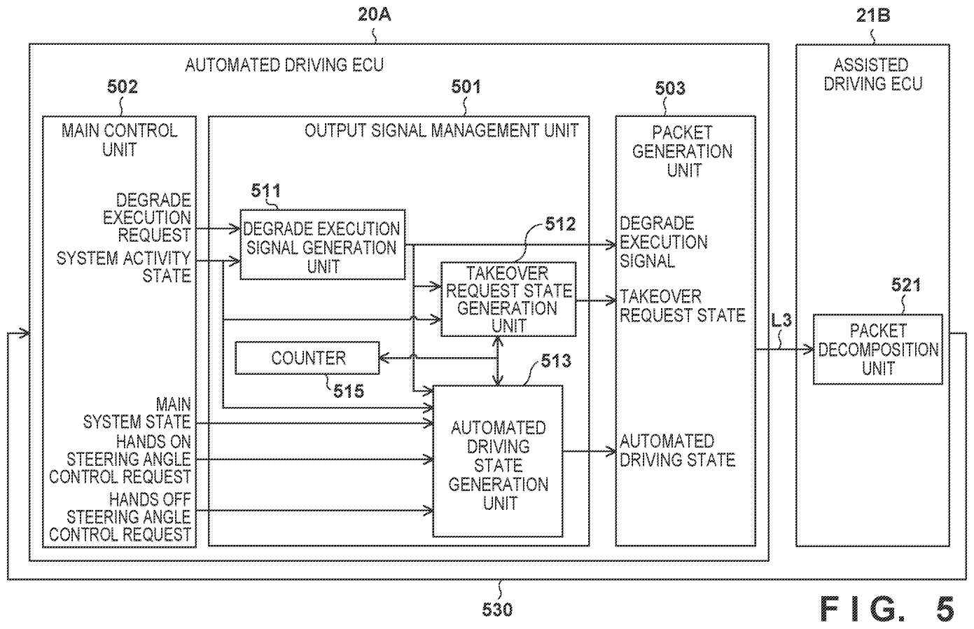

As described above, in the vehicle control device 1 of the present embodiment, in a case where a decrease in the driving control functionality is detected in the first control unit 1A performing automated driving control, instead of the first control unit 1A, the second control unit 1B performs driving control (substitution control) of the vehicle V. By having a configuration with redundancy in terms of including a plurality of control units, the reliability of the automated driving control of the vehicle can be improved. An example of a more detailed configuration of the automated driving ECU 20A and the assisted driving ECU 21B is illustrated in FIG. 5.

In FIG. 5, the automated driving ECU 20A includes a main control unit 502 and an output signal management unit 501. The output signal management unit 501 is also referred to as a signal management unit. The output signal from the main control unit 502 is input into the assisted driving ECU 21B via the output signal management unit 501. It goes without saying that the signal described herein is an example and another signal may be provided. The main control unit 502 is a part of the ECU 20A excluding the output signal management unit 501 and performs control of the automated driving. The output signal management unit 501 processes at least a portion of the output signal of the main control unit 502 and generates a signal for transmission to the ECU 21B. In the signal output by the main control unit 502, a degrade execution request, a system activity state, a main system state, a hands off steering angle control request, and a hands on steering angle control request are included. Herein, the main system state indicates the state of the main switch (on or off). The hands off steering angle control request is a signal indicating whether or not there is a steering angle control request from the autonomous driving unit (ADU) to the electric power steering (EPS) when the automated driving is in level 2B2 or greater. The hands on steering angle control request is a signal indicating whether or not there is a steering angle control request from the ADU to the EPS when the automated driving is in level 1 or lower, or in other words a signal used when lane keeping assistance (LKAS) is active but automated driving is not. The output signal management unit 501, with these signals as input signals, generates three signals, a degrade execution signal, a takeover request state, and an automated driving state. These signals are input into a packet generation unit 503.

The packet generation unit 503 performs packetization of identification information specifying input signals and corresponding signal values and transmits the packets to the assisted driving ECU 21B. A packet decomposition unit 521 of the assisted driving ECU 21B decomposes the receive packet and reproduces the values of the signals. The assisted driving ECU 21B executes processing based on the signal values. Note that the packet generation unit 503 and the packet decomposition unit 521 may be implemented by the ECUs executing a program, or may be constituted by hardware such as an application specific integrated circuit. Note that the packet generation unit 503 may be provided external to the ECU 20A, and the packet decomposition unit 521 may be provided external to the ECU 21B. Furthermore, the ECU 20A and the ECU 21B are connected to one another via a communication line 530, implementing redundancy in terms of communication channels. The ECU 20A communicates with the ECU 21B via these communication channels, allowing instructions, states, and other data to be transmitted and received.

Input Signal of Output Signal Management Unit 501

Next, the signal input from the main control unit 502 to the output signal management unit 501 will be described. The degrade execution request is a signal indicating a request for the ECU 21B to perform substitution control. In the present example, a binary signal is used, with 1 indicating a request, and 0 indicating no request. In the ECU 20A, when a decrease in the functionality of an actuator or sensor under control of the ECU 20A is detected, control is switched from automated driving control by the ECU 20A to degraded control by the ECU 21B. The degrade execution request is a signal that triggers this. The degraded control refers to control in which control ranges and functionality levels are changed and functionality restriction (in other words, degradation) is executed so that a part that has experienced a decrease in functionality is not used, for example.

The system activity state indicates the function being active in automated driving. The system activity state includes a plurality of bits, with a function being allocated to each bit. When a bit value is 1 (also referred to as one or true), the corresponding function is active, and when a bit value is 0 (also referred to as off or false), the corresponding function is not active. The functions represented by the system activity state include an adaptive cruise control (ACC) function, a lane keeping assistance (LKAS) function, automated driving (monitoring necessary) (also referred to as hands off), automated driving (monitoring unnecessary) (also referred to as eyes off), and takeover (MDD).

The adaptive cruise control function is a function of autonomously performing vertical control to drive a vehicle to follow a leading vehicle. Using adaptive cruise control, the leading vehicle can be detected and the vehicle can be driven maintaining a certain inter-vehicle distance. The lane keeping assistance function is a function of detecting white lines specifying a lane and performing lateral control to drive the vehicle within the lane. The automated driving (monitoring necessary) is a function of performing driving control with the driver's hands not on the steering wheel. However, the driver must monitor the surroundings. When using the automated driving system, the orientation of the face of the driver or the line-of-sight of the driver is identified on the basis of images from a driver surveillance camera or the like and whether or not the driver is monitoring the surroundings is determined. The automated driving (monitoring necessary) function is also referred to as automated driving level 2B2 and written as Lv 2B2. When the automated driving (for example, ECU 20A) determines that the driver is not monitoring the surroundings, the driver is warned to monitor the surroundings. In a case where the driver does not comply, degraded control is performed with the ECU 20A remaining the main processing unit. In this case, when the driving is not switched to the driver within a predetermined amount of time, the automated driving system maneuvers the vehicle to a shoulder of the road and stops the vehicle.

The automated driving (monitoring unnecessary) is a function of performing automated driving control that does not require the driver to monitor the surroundings with the driver's hands not on the steering wheel. In the present specification, this is referred to as automated driving level 3. Takeover (MDD) is a state in which the system is requesting the driver to perform manual driving. As described above, in the present example, automated driving includes automated driving (monitoring necessary) and automated driving (monitoring unnecessary), and switching from this state to another state is referred to as takeover. In other words, the transition period from an automated driving state in which the driver is not required to hold the steering wheel to a driving state in which the driver is required to hold the steering wheel is the takeover request state. The upper limit of the duration of the takeover request state is restricted to a certain time period of 4 seconds, for example, and the takeover request state does not remain active if the upper limit is passed. When the duration of the takeover request state reaches the upper time limit, if the main controlling unit is the first control unit 1A, the control unit performs driving control to stop the vehicle at a road shoulder, and if the main controlling unit is the second control unit 1B, the control unit performs driving control to stop the vehicle within the lane currently driving in. Note that automated driving (monitoring necessary) and automated driving (monitoring unnecessary) may be collectively referred to as automated driving (or AD). In this case, active states that are not automated driving state may be referred to as non-automated driving or manual driving.

The main system state is a binary signal that indicates whether the main switch is on or off. When the main system state is on, the automated driving level appropriate for the external environment or the like is selected, and the selected level of automated driving is performed. When the main system state is off, manual driving is continued, without switching to an automated driving state regardless of the external environment. However, in the manual driving state, assisted driving systems, such as LKAS, ACC, and the like, may be performed. In this case, these assisted driving systems are performed in accordance with instructions from the driver.

As described above, the hands off steering angle control request is a signal indicating whether or not there is a steering angle control request from the autonomous driving unit (ADU) to the electric power steering (EPS) when the automated driving is in level 2B2 or greater. When there is a steering angle control request (for example, for a steering operation by the first control unit 1A), it is on, and when there is none, it is off. The hands on steering angle control request is a signal indicating whether or not there is a steering angle control request from the autonomous driving unit (ADU) to the electric power steering (EPS) when the automated driving is in level 1 or lower. When there is a steering angle control request (for example, for a steering operation by the driver), it is on, and when there is none, it is off

Generation of Signal by Output Signal Management Unit

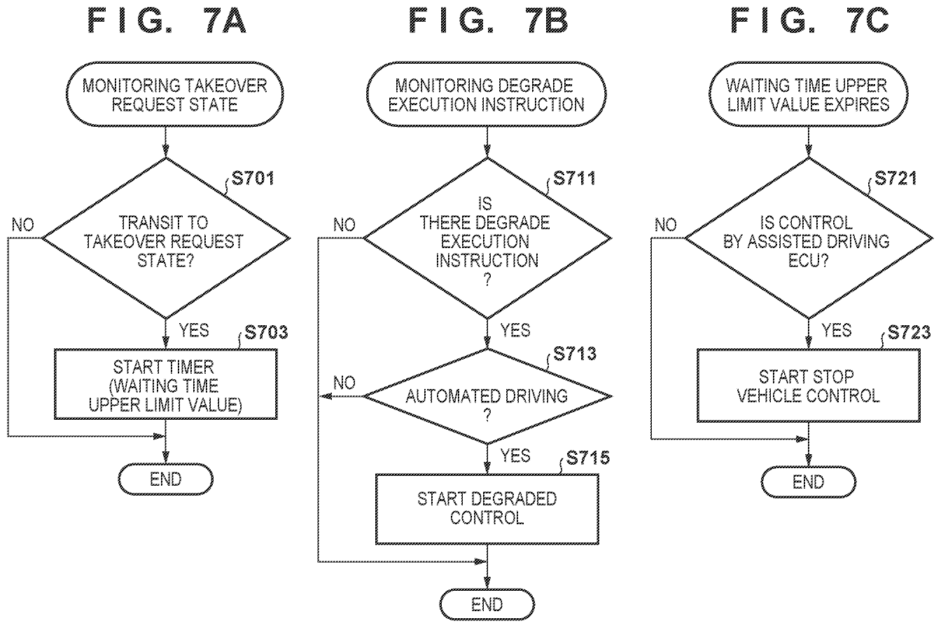

With the signals described above as an input, the output signal management unit 501 generates a signal to be transmitted to the assisted driving ECU 21B via a degrade execution signal generation unit 511, a takeover request state generation unit 512, an automated driving state generation unit 513, and a counter 515 illustrated in FIG. 5. In the generated signal, a degrade execution instruction signal, a takeover request state signal, and an automated driving state signal are included, and these signals are packetized by the packet generation unit 503 and transmitted to the ECU 21B. These signals will be described, however to facilitate this, first the operation of the ECU 21B will be described with reference to FIGS. 7A to 7C. Note that hereinafter, the term “signal” may be omitted from the signal name.

Process of Processing by ECU 21B

FIGS. 7A to 7C illustrate examples of the process of processing by the ECU 21B having received the degrade execution instruction, the takeover request state, and the automated driving state. FIG. 7A illustrates the process of monitoring the takeover request state signal generated by the takeover request state generation unit 512. The ECU 21B monitors the takeover request state signal and determines whether or not there has been a transition from 0 (non-takeover request state=no switch driving request) to 1 (takeover request state=takeover request) (step S701). While the takeover request state is being transitioned to, a timer with a set waiting time upper limit value is started (step S703). This waiting time upper limit value is the upper limit for a waiting time period from when the driver is prompted to takeover to when a switch is actually performed. In this manner, the takeover request state signal is a reference for waiting for takeover.

FIG. 7B illustrates the process of monitoring the degrade execution instruction signal generated by the degrade execution signal generation unit 511. The ECU 21B monitors the degrade execution instruction signal (step S711) and, when there is a degrade execution instruction signal (in other words, to turn it on), the ECU 21B references the automated driving state signal (step S713). Ina case where the automated driving state signal indicates automated driving, degraded control is started (step S715). Note that here, “automated driving” refers to the automated driving state signal being either automated driving (monitoring necessary) or automated driving (monitoring unnecessary). In this manner, when the ECU 20A receives a degrade execution instruction while automated driving is active, the ECU 21B starts performing degraded control in accordance with the instruction. As described above, the degraded control performed by the ECU 21B of the present example includes switching the driving to the driver and performing control to stop the vehicle in a case where takeover has not been performed. Note that in a case where takeover by the driver has been performed, the timing started at step S703 is cancelled.

FIG. 7C illustrates an example of the process when the timer started as illustrated in FIG. 7A expires. When the waiting time upper limit value started at step S703 is reached, the ECU 21B determines whether or not substitution control is currently being performed by the assisted driving ECU (in other words, the ECU 21B) (step S721). In this determination, the degrade execution instruction signal may be referenced, for example. In a case where it is determined that substitution control is being performed, stop vehicle control is started at that point in time (step S723). In stop vehicle control, in a case where the second control unit 1B is provided with sensors or actuators necessary for stopping the vehicle at a road shoulder, the vehicle may be stopped at a road shoulder, and in a case where the second control unit 1B is not provided as such, the vehicle may be stopped within the lane currently driving in. In this case also, if the lane currently driving in is adjacent to the road shoulder, control may be performed to maneuver the vehicle toward the road shoulder, or if the lane currently driving in is adjacent to the central line, control may be performed to maneuver the vehicle toward the central line. Also, it goes without saying that control to take safety precautions such turning on the hazard lamps may also be performed.

Degrade Execution Signal

Now that the signals generated by the output signal management unit 501 have been described, how the signals are generated will be described. The degrade execution signal generation unit 511, input with a degrade execution request and a system activity state, generates a degrade execution instruction signal. The generation rules are as follows.

Condition 1: The system activity state is automated driving (in other words, either automated driving (monitoring necessary) or automated driving (monitoring unnecessary).

Condition 1′: The degrade execution request is on.

Output 1: The degrade execution instruction signal is set to on (degrade execution instruction). Note that in a case where the conditions are not satisfied, the degrade execution instruction signal is set to off (no instruction).

In other words, in a case where a degrade execution request occurs while automated driving is active and only in such a case, the degrade execution instruction signal is set to on.

Takeover Request State Signal

The takeover request state generation unit 512, input with the degrade execution instruction signal and the system activity state generated by the degrade execution signal generation unit 511, generates a takeover request state signal. The generation rules are as follows.

Case 1

Condition 2-1: The system activity state is takeover.

Output 2-1: The takeover request state signal is set to on (active). While the system activity state is “takeover”, this output is maintained, and when a state other than “takeover” is transitioned to, the takeover request state signal is set to off.

Case 2

Condition 2-2: The degrade execution instruction signal is on.

Condition 2-2′: The current takeover request state signal is on (active).

Operation 2-2: The counter 515 is started. The counter value is a predetermined value (MDD state counter value). The counter value, as described below, is only required to cover the period of time in which the system activity state may transition to a state other than “takeover” in line with the timing of the degrade execution instruction signal being set to on, for example.

Output 2-2: While the counter is active, the takeover request state is kept as on.

Condition 2-3: The counter times out.

Output 2-3: Condition 2-1 and output 2-1 are followed.

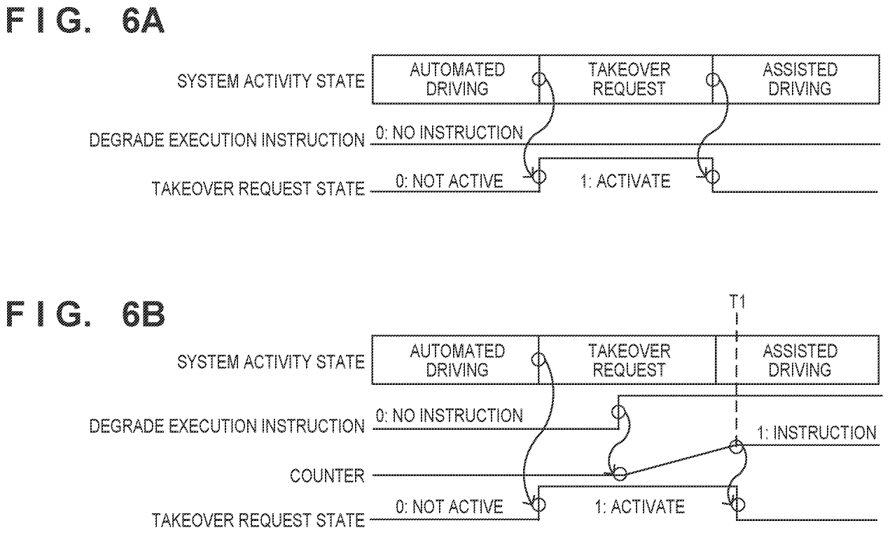

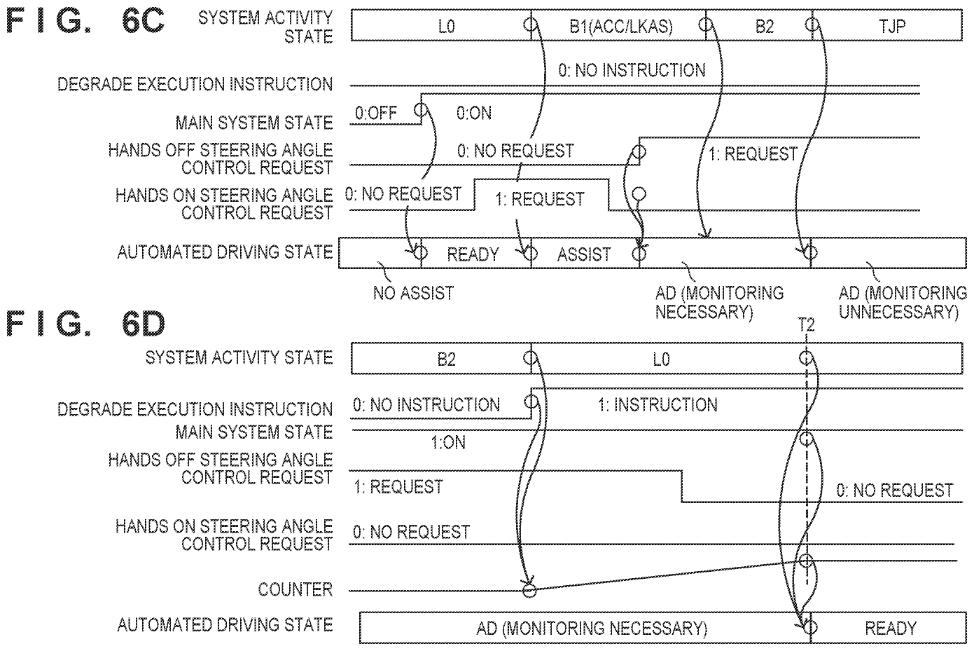

FIG. 6A and FIG. 6B illustrate examples of signal generation by the takeover request state generation unit 512. FIG. 6A illustrates an example of case 1 described above. In FIG. 6A, the system activity state, i.e., an input signal, transitions from “automated driving” to “takeover” and then to “assisted driving”. During this time, the degrade execution instruction signal is kept as off. This case corresponds to condition 2-1. Thus, when the system activity state transitions to “takeover”, the takeover request state signal is set to on, and when the system activity state transitions to “assisted driving”, the takeover request state signal is set to off.

FIG. 6B illustrates an example of case 2 described above. In FIG. 6B, the system activity state, i.e., an input signal, transitions from “automated driving” to “takeover” and then to “assisted driving”, as in FIG. 6A. Also, in the time the system activity state is being set to“takeover”, the degrade execution instruction is set to on. This case plays out according to condition 2-1, and the takeover request state is set to on when the system state transitions to “takeover”. Furthermore, when the degrade execution instruction is set to on during this time, condition 2-2 and condition 2-2′ are satisfied, and thus the counter 515 is started. The takeover request state is kept as on until the counter 515 times out. At a timing T1 when the counter times out, the takeover request state signal is set to off in accordance with the system activity state (assisted driving) at this time. Note that in FIG. 6B, the counter is schematically illustrated with the counter value increasing as time elapses.

The reason for generating the signal illustrated in FIG. 6B will be described. This signal generation may also be referred to as latch control of the takeover request state because of the mechanism that maintains the takeover request state for the time corresponding to the counter value. As seen in FIG. 6B, when the system activity state is first set to “takeover”, this state is maintained until being set to another state such as “assisted driving”. However, in the case of FIG. 6B, at the time when the degrade execution instruction signal is set to on or slightly before, the system activity state may temporarily transition to a state other than “takeover”, and then return back to “takeover” This is because, in a case where an event (a decrease in functionality) occurs triggering a degrade execution request with the ECU 20A in a state of waiting for takeover, the system activity state first switches to a state other than “takeover” in accordance with the event. When, in accordance with the event, the ECU 21B is required to perform substitution control, a degrade execution request is output from the ECU 20A. Together with the degrade execution request, the system activity state transitions to “takeover”. In this manner, when substitution control occurs while waiting for takeover, the system activity state may not be maintained in “takeover” and may temporarily transition to a state other than “takeover”. In other words, the system activity state may transition from “takeover” to another state to “takeover”. In a case where the system activity state has transitioned in this manner, following case 1, when a takeover request state signal is generated, the takeover request state signal and the system activity state transition in sync from on to off to on.

The ECU 21B having received the takeover request state signal, following the process of FIG. 7A, the timer of a predetermined time (for example, 4 seconds) is started while the takeover request state signal is rising. In a case where takeover has not been performed when the predetermined time expires, in the present example, the ECU 21B stops the vehicle within the lane. Here, if the takeover request state signal switches from on to off to on as described above, at the second on (rise), the timing started at the first rise is ignored and timing is started anew. In other words, the time for waiting for takeover is extended by the time measured starting from when the takeover request state signal was first set to on. Ina case where substitution control is performed by the ECU 21B, a decrease in functionality of the sensors and actuators belonging to the first control unit 1A may occur. Thus, extending this time for waiting for takeover is not desirable. Here, in a case where an instruction for the takeover request state to be set to substitution control causes the system activity state to transition from “takeover” to another state to “takeover”, the takeover request state signal is latched as “takeover” and stays as on without syncing with the change in the system activity state. Thus, the counter value to be set should be set to cover the time period of “another state” in the transition from “takeover” to another state to “takeover”. This time period is very short, but can be set with extra time without problem. The specific time (counter value) may be determined by experiment, for example.

By generating a takeover request state signal as described above, the control state, in particular the takeover state, can be appropriately handed over from the first control unit 1A to the second control unit 1B. Thus, even when the ECU 21B comes to perform substitution control during degraded control by the ECU 20A, degraded control can be performed without extending the takeover waiting time.

Automated Driving State Signal

The automated driving state generation unit 513, input with five signals: a degrade execution instruction signal, a system activity state, a main system state, a steering angle control request, and a steering angle control request (advanced driver assistance system, ADAS) generated by the degrade execution signal generation unit 511, generates an automated driving state signal. Herein, the steering angle control request is a signal for requesting electric power steering (EPS) to control the steering and is sent from the automated driving ECU 20A to the ECU 22A, for example. The steering angle control request (ADAS) is a similar signal, however, the former steering angle control request is a control signal for automated driving when the driver performs no driving operations, and the later steering angle control request (ADAS) is a signal for performing assisted steering that assists the steering operation of the driver. In other words, the steering angle control request (ADAS) indicates that driver operations are being performed. The generation rules for the automated driving state signal are as follows.

Case 1

Condition 3-1: The system activity state is automated driving (monitoring unnecessary).

Output 3-1: The automated driving state signal is set to “automated driving (monitoring unnecessary)”. This means automated driving that does not require the driver to monitor the surroundings.

Case 2

Condition 3-2: Condition 3-1 is not satisfied.

Condition 3-2′: The system activity state is “automated driving (monitoring necessary)” or the steering angle control request is on (request) and the steering angle control request (ADAS) is off (no request).

Output 3-2: The automated driving state signal is set to “automated driving (monitoring necessary)”. This means automated driving that requires the driver to monitor the surroundings.

Case 3

Condition 3-3: Neither condition 3-1 nor condition 3-2 is satisfied.

Condition 3-3′: The system activity state is “adaptive cruise control” or “lane keeping assistance”.

Output 3-3: The automated driving state signal is set to “assist”. This means that automated driving is not performed, but that assisted driving functions are in operation.

Case 4

Condition 3-4: None of condition 3-1 to condition 3-3 are satisfied.

Condition 3-4′: The main system state is on.

Output 3-4: The automated driving state signal is set to “ready”. This means that automated driving is not performed, but that depending on the environment, automated driving can be performed.

Case 5

Condition 3-5: None of condition 3-1 to condition 3-4 are satisfied.

Output 3-5: The automated driving state signal is set to “no assist”. This means that driving assistance and automated driving are not performed.

An example of from case 1 to case 5 described above is illustrated in FIG. 6C. In FIG. 6C, TP for the system activity state indicates a state in which automated driving not requiring monitoring by the driver is being performed, and B2 indicates level 2B2, or in other words, a state in which automated driving requiring monitoring by the driver is being performed. B1 indicates a state in which adaptive cruise control and lane keeping assistance are in operation. L0 indicates level 0, or in other words, a manual driving state. In FIG. 6C, curved arrow lines connect conditions and outputs and correspond in order from the right side of the diagram to cases 1, 2, 2, 3, and 4. Case 2 has two lines because condition 3-2′ includes both the clause before the “or” of “the system activity state is “automated driving (monitoring necessary)” and the clause after the “or” of “the steering angle control request is on (request) and the steering angle control request (ADAS) is off (no request).

The automated driving state generation unit 513 also generates an automated driving state signal in accordance with the following conditions.

Case 6

Condition 3-6: The degrade execution instruction signal is on (instruction).

Condition 3-6′: The automated driving state is currently “automated driving (monitoring necessary)” or “automated driving (monitoring unnecessary).

Operation 3-6: The counter 515 is started. The counter value is a predetermined value (AD state counter value). In the process of FIG. 7B, the counter is used to prevent automated driving not being determined, despite being automated driving, and degraded control not being performed when a degrade execution instruction is present. The operation described above is prevented by the driving state signal being latched in “automated driving” for the time period of the counter value. Once the counter is started, it is not stopped until it times out. The set counter value (in other words, the predetermined amount of time) should be an amount of time covering the time period from when the ECU 20A transmits the degrade execution instruction signal to when the ECU 21B references the automated driving state signal. The time period may be determined by experiment, for example.

Output 3-6: As described above, while the counter is operating, the automated driving state signal is output as “automated driving (monitoring necessary)” or “automated driving (monitoring unnecessary)”. Alternatively, when the counter is started, if the automated driving state signal is “automated driving (monitoring necessary)” or “automated driving (monitoring unnecessary)”, that value may be maintained and output.

Condition 3-6″: The counter times out.

Output 3-6″: The automated driving state signal is generated in accordance with case 1 to case 5.

FIG. 6D illustrates an example of case 6 described above. As illustrated in FIG. 6D, in a case where a degrade execution request is sent from the ECU 20A to the ECU 21B and the degrade execution instruction signal is set to on, together with this, the system activity state is changed to a post-degraded state, or, in other words, changed to manual driving (level 0). At this time, in a case where the automated driving state signal, in sync with the change in the system activity state, changes from “automated driving” to a state other than “automated driving”, in step S713 as per the process of FIG. 7B, automated driving is determined to be false, and degraded control may not be performed. Here, by starting the counter at this time, the automated driving state signal is maintained without change until a time T2 when the counter times out. Also, at time T2, a value of the automated driving state signal corresponding to the condition at that time is generated. In the example of FIG. 6D, it transitions to “ready”. By latching the automated driving state signal for a predetermined amount of time in this manner, the automated driving state can be appropriately taken over by the ECU 21B and substitution control can be performed.

By generating an automated driving state signal as described above, the control state, in particular the automated driving state, can be appropriately handed over from the first control unit 1A to the second control unit 1B. In other words, the ECU 20A holds the information (the takeover request state signal and the automated driving state signal) indicating the state of control of the automated driving received by the ECU 21B for a time at least until the ECU 21B references the information. Thus, even when the ECU 21B comes to perform substitution control during automated driving by the ECU 20A, substitution control by the ECU 21B can be reliably performed. Note that in the names of the signals, in principle, the term “request” has been used for signals input to the output signal management unit 501, and the term “instruction” has been used for signals output from the output signal management unit 501. However, there is no particular difference between them, and they are used with essentially the same meaning.

### Summary of Embodiments

1. A first embodiment of the present invention provides a vehicle control device (1) for controlling automated driving of a vehicle, including:
a first control unit (20A) configured to perform driving control of the vehicle; and
a second control unit (21B) configured to perform driving control of the vehicle according to at least a substitution instruction from the first control unit,
wherein when the first control unit transmits the substitution instruction to the second control unit, the first control unit holds, for a predetermined amount of time, information indicating a state of control of automated driving to be transmitted to the second control unit.

According to the configuration described above, when the substitution instruction is transmitted to the second control unit, the information indicating a state of control of automated driving to be transmitted from the first control unit to the second control unit can be delayed for a predetermined amount of time. This allows the information indicating the state of control of automated driving to stabilize and the information to be appropriately handed over to the second control unit.

2. A second embodiment of the present invention provides the vehicle control device according to the first embodiment,
wherein the information indicating the state of control of the automated driving includes information indicating a state of takeover.

According to this configuration, when the substitution instruction is transmitted to the second control unit, the information indicating the state of takeover to be transmitted from the first control unit to the second control unit can be delayed for a predetermined amount of time. This allows the information indicating the state of takeover to stabilize and the information to be appropriately handed over to the second control unit.

3. A third embodiment of the present invention provides the vehicle control device according to the second embodiment,
wherein when the first control unit is waiting for takeover, the first control unit transmits information indicating waiting for takeover as the information indicating the state of takeover, and
wherein in a case where the substitution instruction is transmitted to the second control unit when takeover is being waited for, for a predetermined amount of time from when the substitution instruction is transmitted, the information indicating waiting for takeover is transmitted to the second control unit as the information indicating the state of takeover.

According to the configuration described above, the state indicating waiting for takeover can be stably handed over to the second control unit, and an extension of the waiting time for takeover can be prevented.

4. A fourth embodiment of the present invention provides the vehicle control device according to the third embodiment,
wherein the second control unit

starts a timer for measuring waiting time for takeover when the information indicating waiting for takeover is received as the information indicating the state of takeover, and

performs degraded control in a case where automated driving is active when the substitution instruction is received.

According to the configuration described above, the state indicating waiting for takeover can be stably handed over to the second control unit, and, in the second control unit, an extension of the waiting time for takeover can be prevented.

5. A fifth embodiment of the present invention provides the vehicle control device according to the third or fourth embodiment,
wherein the predetermined amount of time is an amount of time that covers a time period from when a state of waiting for takeover by the first control unit transitions to a state other than the state of waiting for takeover in accordance with an event that triggers the substitution instruction until when the state of waiting for takeover is transitioned back to together with the substitution instruction.

According to the configuration described above, the state indicating waiting for takeover can be stably handed over to the second control unit, and, in the second control unit, an extension of the waiting time for takeover can be prevented.

6. A sixth embodiment of the present invention provides the vehicle control device according to the first embodiment,
wherein the information indicating the state of control of automated driving includes information indicating a state of driving.

According to the configuration described above, when the substitution instruction is transmitted to the second control unit, the information indicating the state of driving to be transmitted from the first control unit to the second control unit can be delayed for a predetermined amount of time. This allows the information indicating the state of driving to stabilize and the information to be appropriately handed over to the second control unit.

7. A seventh embodiment of the present invention provides the vehicle control device according to the sixth embodiment,
wherein the first control unit transmits information corresponding to a state of automated driving performed by the first control unit as the information indicating the state of driving, and
wherein in a case where the substitution instruction is transmitted to the second control unit when the information corresponding to the state of automated driving indicates automated driving is active, for a predetermined amount of time from when the substitution instruction is transmitted, information indicating automated driving is active is transmitted to the second control unit as the information corresponding to the state of automated driving.

According to the configuration described above, the information corresponding to the state of automated driving can be stably handed over to the second control unit, and substitution control by the second control unit can be reliably performed.

8. An eighth embodiment of the present invention provides the vehicle control device according to the seventh embodiment,
wherein the second control unit

starts a timer for measuring waiting time for takeover when the information indicating waiting for takeover is received as the information indicating the state of takeover, and

performs degraded control in a case where automated driving is active when the substitution instruction is received.

According to the configuration described above, the information corresponding to the state of automated driving can be stably handed over to the second control unit, and when the second control unit receives a substitution instruction, control depending on the state of automated driving can be performed.

9. A ninth embodiment of the present invention provides the vehicle control device according to the seventh or eighth embodiment,
wherein the predetermined amount of time is an amount of time that covers a time period from when the first control unit transmits the substitution instruction until when the second control unit references the information corresponding to the state of automated driving.

According to the configuration described above, the information corresponding to the state of automated driving can be stably handed over to the second control unit, and when the second control unit receives a substitution instruction, control depending on the state of automated driving can be performed.

The invention is not limited to the foregoing embodiments, and various variations/changes are possible within the spirit of the invention.

What is claimed is:

1. A vehicle control device for controlling automated driving of a vehicle, comprising:
a first control unit configured to perform driving control of the vehicle; and
a second control unit configured to perform driving control of the vehicle according to at least a substitution instruction from the first control unit,
wherein when the first control unit transmits the substitution instruction to the second control unit, the first control unit holds, for a predetermined amount of time, information indicating a state of control of automated driving to be transmitted to the second control unit.

2. The vehicle control device according to claim 1,
wherein the information indicating the state of control of the automated driving includes information indicating a state of takeover.

3. The vehicle control device according to claim 2,
wherein when the first control unit is waiting for takeover, the first control unit transmits information indicating waiting for takeover as the information indicating the state of takeover, and
in a case where the substitution instruction is transmitted to the second control unit when takeover is being waited for, for a predetermined amount of time from when the substitution instruction is transmitted, the information indicating waiting for takeover is transmitted to the second control unit as the information indicating the state of takeover.

4. The vehicle control device according to claim 3,
wherein the second control unit
starts a timer for measuring waiting time for takeover when the information indicating waiting for takeover is received as the information indicating the state of takeover, and
performs degraded control in a case where automated driving is active when the substitution instruction is received.

5. The vehicle control device according to claim 3,
wherein the predetermined amount of time is an amount of time that covers a time period from when a state of waiting for takeover by the first control unit transitions to a state other than the state of waiting for takeover in accordance with an event that triggers the substitution instruction until when the state of waiting for takeover is transitioned back to together with the substitution instruction.

6. The vehicle control device according to claim 1,
wherein the information indicating the state of control of automated driving includes information indicating a state of driving.

7. The vehicle control device according to claim 6,
wherein the first control unit transmits information corresponding to a state of automated driving performed by the first control unit as the information indicating the state of driving, and
in a case where the substitution instruction is transmitted to the second control unit when the information corresponding to the state of automated driving indicates automated driving is active, for a predetermined amount of time from when the substitution instruction is transmitted, information indicating automated driving is active is transmitted to the second control unit as the information corresponding to the state of automated driving.

8. The vehicle control device according to claim 7,
wherein when the second control unit receives the substitution instruction and receives the information indicating that the automated driving is performed as the information corresponding to the state of the automated driving, the second control unit performs degraded control.

9. The vehicle control device according to claim 7,
wherein the predetermined amount of time is an amount of time that covers a time period from when the first control unit transmits the substitution instruction until when the second control unit references the information corresponding to the state of automated driving.

10. A vehicle that performs driving control by a vehicle control device for controlling automated driving of the vehicle,
the vehicle control device including:
a first control unit configured to perform driving control of the vehicle; and
a second control unit configured to perform driving control of the vehicle according to at least a substitution instruction from the first control unit,
wherein when the first control unit transmits the substitution instruction to the second control unit, the first control unit holds, for a predetermined amount of time, information indicating a state of control of automated driving to be transmitted to the second control unit.
